(19) United States
(12) Patent Application Publication
(10) Pub. No.: US 2012/0323993 A1
(43) Pub. Date: Dec. 20, 2012

(54) DATA PROCESSING DEVICE AND DATA PROCESSING METHOD

(75) Inventor: Takaya KATO, Tokyo (JP)

(73) Assignee: THE BANK OF TOKYO - MITSUBISHI UFJ, LTD., Tokyo (JP)

(21) Appl. No.: 13/238,585

(22) Filed: Sep. 21, 2011

(30) Foreign Application Priority Data
Jun. 16, 2011 (JP) 2011-133908

(51) Int. Cl. G06F 15/16

(52) U.S. Cl. 709/203

(57) ABSTRACT

A data processing device connected to a client via a network including a Cookie generator which generates a Cookie, a calculator which calculates a secret value using the Cookie generated by the Cookie generator and a hidden key which is a predetermined character string, a screen sender which sends screen data which includes the Cookie generated by the Cookie generator and the secret value calculated by the calculator to the client, a table which stores the Cookie, a request telegraph receiver which receives a request telegraph which includes the Cookie and the secret value from the client, a Cookie verification unit which verifies whether the Cookie stored in the table and a received Cookie which is a Cookie included in the request telegraph, match, and a secret value verification unit which verifies whether a value calculated using the received Cookie and the hidden key matches a secret value included in the request telegraph.

### CROSS REFERENCE TO RELATED APPLICATION

This application is based upon and claims the benefit of priority from the prior Japanese Patent Application No. 2011-133908, filed on Jun. 16, 2011; the entire contents of which are incorporated herein by reference.

### BACKGROUND OF THE INVENTION

### Field of the Invention

The present invention is related to a device and a method for authentication. In particular, the present invention is related to a device and method for increasing security during a shift in sessions.

User identification and session management has been conventionally performed using Cookies (HTTP Cookie) between a Web server and a client's browser in a system which provides Web services to the client from the Web server (For example, see Japan Laid Open Patent 2000-322353).

However, this system is problematic in the case where a Coolie is leaked to a third party who can then impersonate a user with the Cookie and invalidly access data.

In addition, conventionally, Cross Site Request Forgeries in which a forced transfer to a site from an external page of a site which is flooded with improper accesses has led to demands for a technology which allows only access from a valid transfer source as the object of a cross site request forgery.

Thus, the present invention provides a data processing device and a data processing method in which access control with a high level of safety can be obtained even if a Cookie is leaked without requiring complex procedures such as introducing a special program in a client.

In addition, the present invention provides a data processing device and a data processing method for performing authentication with excellent security by allowing access to a web page via a valid screen transfer.

### BRIEF SUMMARY OF THE INVENTION

A data processing device related to one embodiment of the present invention which is connected to a client via a network includes a Cookie generator which generates a different Cookie for each screen displayed, a calculator which calculates a secret value using the Cookie generated by the Cookie generator and a hidden key which is a predetermined character string, a screen sender which sends screen data which includes the Cookie generated by the Cookie generator and the secret value calculated by the calculator to the client, a screen table which correlates a transferable screen which is transferable from a screen corresponding to the screen data, with the Cookie and stores both, a request telegraph receiver which receives a request telegraph which includes the Cookie, the secret value and request screen transfer destination data from the client, a Cookie verification unit which verifies whether the Cookie stored in the screen table and a received Cookie which is a Cookie included in the request telegraph, match, a screen verification unit which verifies whether a screen transfer destination which is desired by the client included in the request screen transfer destination data, is included in the transferable screen corresponding to the Cookie stored in the screen table, and a secret value verification unit which verifies whether a value calculated using the received Cookie and the hidden key matches a secret value included in the request telegraph.

A data processing method in a data processing device connected to a client via a network includes generating a different Cookie for each screen displayed, calculating a secret value using the generated Cookie and a hidden key which is a predetermined character string, sending screen data which includes the generated Cookie and the calculated secret value to the client, correlating a transferable screen which is more transferable than a screen corresponding to the screen data, with the Cookie and storing both, receiving a request telegraph which includes the Cookie, the secret value and request screen transfer destination data from the client, verifying whether the Cookie stored in a table matches a received Cookie which is a Cookie included in the request telegraph, verifying whether a screen transfer destination which is desired by the client included in the request screen transfer destination data, is included in the transferable screen corresponding to the Cookie stored in the screen table, and verifying whether a value calculated using the received Cookie and the hidden key matches a secret value included in the request telegraph.

According to the present invention, complex procedures such as introducing a special program in a client are not required and it is possible to reduce the danger of misuse by performing access control even in the case where a Cookie is leaked.

In addition, according to the present invention, a data processing device and a data processing method are provided for performing authentication with excellent security by allowing access to a web page via a valid screen transfer.

### BRIEF DESCRIPTION OF THE DRAWINGS

FIG. 1 is a functional block diagram which shows the structure of a data processing system which includes a data processing device related to one embodiment of the present invention.

FIG. 2 is an exemplary diagram of a screen transfer in a data processing device related to one embodiment of the present invention.

FIG. 3 is a flowchart for explaining the process of sending screen data to a client in a data processing device related to one embodiment of the present invention.

FIG. 4 is a flowchart for explaining the process of sending a screen display request from a client and judging its validity in a data processing device related to one embodiment of the present invention.

### DETAILED DESCRIPTION OF THE INVENTION

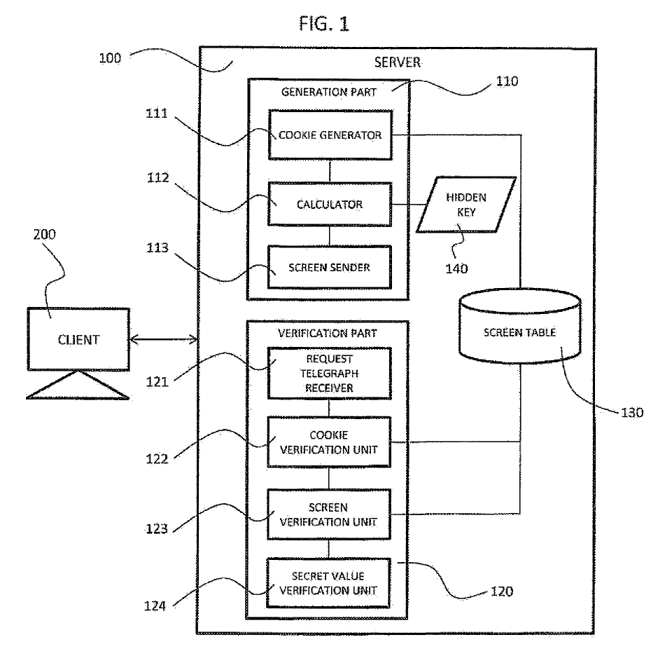

FIG. 1 is a functional block diagram which shows the structure of a data processing system which includes a data processing device related to one embodiment of the present invention. Here, a server 100 is shown as an example of the data processing device.

Referring to FIG. 1, the data processing system related to one embodiment of the present invention is arranged with a server 100 which is a data processing device and a client 200, in the present embodiment, the server 100 and the client 200 are connected with a network. The server 100 includes a generation part 110, a verification unit 120, a screen table 130 and a hidden key 140. The server 100 is one or more physical servers which can be connected to one of more networks and is network connected to the client 200. In addition, the server 100 may be a Web server for example. The client 200 is a terminal device operated by a user. The client 200 is realized by a device installed with a program, having a CPU (central processing unit) such as a personal computer, PDA, mobile phone or smart phone.

The generation part 110 is a component used for the generation of screen data which is sent from the server 100 to the client 200 and includes a Cookie generator 111, a calculator 112 and a screen sender 113. In addition, the verification unit 120 verifies data within a telegraph sent from a client with data stored within the server 100 and judges whether the telegraph sent from the client as a request is valid. The verification unit 120 includes a request telegraph receiver 121, a Cookie verification unit 122, a screen verification unit 123 and a secret value verification unit 124.

First, the structure of the generation part 110 is explained.

The Cookie generator 111 generates Cookies which are sent to the client 200. Cookies may be generated for example by JAVA (Registered Trademark), and a Servlet or JSP may be used at this time. In addition, CGI (Common Gateway Interface) or PHP: Hypertext Preprocesses or other known Cookie generation methods can be used. Control is performed so that different Cookies are generated for each screen. As a result, each time a different value may be generated by a random function as the value of a Cookie.

The generated Cookie is stored in a screen table 130 which is correlated with a screen which corresponds to the Cookie. Here, a Cookie is generated when a telegraph including a screen request is received from the client 200 and [a screen corresponding to the Cookie] refers to a screen in which the generated Cookie is included in a statement on the screen. For example, the Cookie has a value [sdj4085443gzsdlkjglh] and in the case where the screen corresponding to the Cookie is a transfer screen in an Internet banking site, a value [/transfer] is correlated and stored in advance as screen data. The screen data has a unique value for each screen and a plurality of screens may have the same value for the purposes of simplifying a system. For example, the screen table 130 may appear as the chart 1 below.

### Chart 1

| Cookie | Screen |
|---|---|
| sdj4085443qzsdlkjglh | /transfer |
| kkgi4893ndfskdalajdk | /inquiry |

In the chart 1, a Cookie correlated with each screen is stored, the Cookie [sdj4085443gzsdlkjglh] is correlated with the screen [/transfer] and stored and the Cookie [kkgi4893ndfskdalajdk] is correlated with the screen [/inquiry] and stored. The screen table 130 is updated for each Cookie generated.

Furthermore, the Cookie may be correlated with a transfer source screen and stored, or the Cookie may be correlated with a transfer destination screen which can be transferred from a screen when the Cookie is generated and stored in the screen table 130. In the latter case, one transferable screen or more is correlated with one Cookie. In addition, the chart 1 may be generated for each client, or the chart 1 may be generated for each session if a plurality of sessions exists between the client 200 and server 100. In this way, when the client and server are different, a value of different Cookies is correlated with a screen.

The calculator 112 calculates a secret value using a Cookie generated by the Cookie generator 111. A secret value is a value set as a secret parameter in screen data sent to the client 200 and sent. The secret value is not displayed in the screen of the client 200. For example, the secret value is set as a hidden parameter in a <form> tag of a HTML (Hypertext Markup Language).

In the calculator 112, a hidden key 140 is used together with a Cookie to calculate a secret value. The hidden key 140 is a predetermined number string or character string, is a value which is stored as internal memory of the server 100 and can not be confirmed from the client 200. The hidden key 140 may be a fixed value or a variable value which shifts according to a predetermined rule. A function used in the calculation of the secret value may be a known function or function independently arranged. For example, a hash function may be used as a known function. The hash function may be MD5 or SHA-1, SHA-256, for example or any other hash function.

The screen sender 113 sends a Cookie generated by the Cookie generator 111 and a secret value calculated by the calculator 112 to the client 200 together with, other screen data. The secret value is set to screen data in a format which is not displayed in the client 200. The screen data sent to the client 200 may also be, for example, a HTTP object and a Cookie may be set to a Set-Cookie including a Set-Cookie header as a part of a HTTP header. In addition, the secret value may be set to a HTML hidden field for example as stated above.

A secret value does not have to be stored in the server 100 in advance unlike a Cookie. After the secret value is calculated by the calculator 112 and until it is set to screen data, the secret value is temporarily stored in a temporary memory region such as a cache of the server 100, and then the secret value may be expressly deleted from the temporary memory region of the server 100 by the screen sender 113. By not storing the secret value in the server 100 there is no fear of the secret value being leaked from the server 100 and in terms of security it is possible to carry out access management when verifying the secret value as explained below.

Specifically, the Cookie [sdj4085443qzsdlkjglh] is set by the Set-Cookie header which is one part of a HTTP header in the screen data which is sent, for example, and a hidden value [jfi3954 kd] which is generated using the Cookie and the hidden key is set in a hidden field and sent.

Next, the structure of the verification unit 120 is explained.

In the case where the screen sender 113 receives a request for the display of another screen from the client 200 of the sending source which sends screen data including a Cookie and a secret value, that is, in the case of receiving a request for transferring from this screen to another screen, the verification unit 120 checks the validity of this screen display request.

A screen display request sent from the client 200 is sent to the request telegraph receptor 121. A Cookie and secret value sent from the screen sender 113, data which shows the present screen, that is, a transfer source screen, and data which shows a screen which is to be displayed, that is, a transfer destination screen, are included in the screen display request sent from the client 200 and received by the server 100. For example, the transfer source screen is referenced to as a REFERER value. That is, the URL of the transfer source screen is referenced as a REFERER value in the server 100.

The Cookie verification unit 122 verifies whether the received Cookie matches the Cookie which is stored in the screen table 130 and which corresponds to the transfer source screen. For example, in the case where the present screen is [/transfer], the Cookie verification unit 122 verifies whether the Cookie [sdj41085443azsdlkjglh] which is stored and corresponds to [/transfer] matches the received Cookie.

The Cookie verification unit 122 judges that this access attempt is invalid and denies access in the case where the received Cookie does not match the Cookie stored in the screen table 130, or in the case where the screen display request does not include a Cookie to begin with.

The screen verification unit 123 checks whether it is possible to move from this screen to a transfer destination screen. That is, the screen verification unit 123 checks whether transfer from the transfer source screen to a page which can not originally be directly transferred to, has been requested or not by the screen transfer request. Data of a transfer destination screen which can be transferred to from a certain transfer source screen is stored as internal memory within the server 100. For example, a referrer which is generated in the transfer source screen may be used as data which shows a transfer source screen.

In the case where transfer from the transfer source screen to a transfer destination screen cannot be carried out, the screen verification unit 123 judges that this access attempt is invalid and denies access.

Furthermore, unlike the description above, as a transformation example, data which shows the transfer source screen does not have to be received from the client 200. In this case, the Cookie verification unit 122 searches for a Cookie in the screen table 130 which matches the received Cookie, and in the case where a matching Cookie exists, confirms a screen correlated with the matching Cookie and checks whether transfer from the corresponding screen to a transfer destination screen is possible.

The secret value verification unit 124 performs the same calculation again as the calculation performed in the calculator 112 using the Cookie received from the client 200 and verifies whether this calculated value matches a secret value which is included in the screen display request received from the client 200. Alternatively, the secret value verification unit 124 performs the same calculation again as the calculation performed in the calculator 112 using the Cookie received from the client 200 and confirms whether the secret value and the calculated value satisfy a predetermined function.

In the case where the received secret value and the recalculated secret value do not match, or in the case where a secret value is not included in the screen display request to begin with, the verification unit 120 judges that an invalid access attempt has been made and can deny access.

As stated above, in the case where Cookies do not match in the Cookie verification unit 122, and where it is judged that a transfer destination screen can not be transferred to in the screen verification unit 123, and in the case where a secret value does not match a recalculated value in the secret value verification unit 124, the verification unit 120 judges that the screen display request is invalid and can deny any of these access attempts as invalid.

According to the data processing device related to one embodiment of the present invention a Cookie can be used in session management, that is, management of each screen transfer. In addition, even if a Cookie is leaked to a third party, because the secret value can not be calculated or guessed with the Cookie alone by the third party and processes related to the secret value within the server can not be known, it is possible to prevent invalid access using a leaked Cookie.

In addition, according to the data processing device related to one embodiment of the present invention, by having a screen table 130 which stores a screen correlated with a Cookie and by confirming a transferable screen by checking the screen table 130 it is possible to remove invalid access attempts from valid screen transfers.

Furthermore, a table which stores just Cookies maybe included in a more simplified data processing device, which does not include the screen table 130, and a screen is not correlated with a Cookie. In this case, because a Cookie is not correlated with a screen an invalid access attempt can not be removed from valid screen transfers as in the case where of having the screen table 130 stated above. However, because a Cookie which is managed in the table is not managed for each screen and does not require correlating with a screen and data being stored, the amount of data used for storing a Cookie in the data processing device decreases and the speed of referencing a table in the Cookie verification unit compared to the case where a screen table is referenced is relatively faster. In addition, the effects of an increase in the level of security by using a secret value are also preserved as before in this more simplified data processing device.

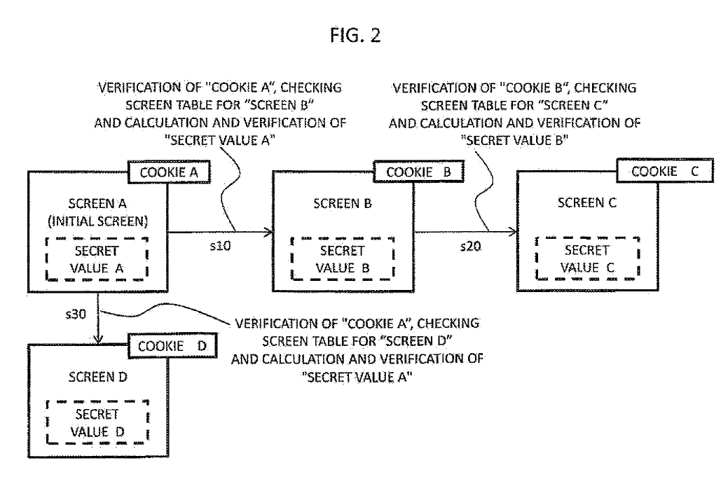

Next, an example of screen transfer in the data processing device related to an embodiment of the present invention is explained while referring to FIG. 2.

FIG. 2 is an exemplary diagram of a screen transfer in the data processing device related to an embodiment of the present invention.

Referring to FIG. 2, a screen A is first displayed as an initial screen. Cookie A′ and secret value A″ are set as screen data in the screen A. Cookie A′ is correlated with Screen A and stored in the screen table 130.

In the case (s10) of receiving a display request of screen B from the client 200, the server 100 verifies a Cookie within the received data with the Cookie A′, confirms whether a transfer source screen is the screen A, and confirms whether screen B can be transferred. In addition, the server 100 confirms whether the received secret value A″ matches a recalculated secret value using the received Cookie, and screen B is displayed when a valid access attempt is judged to have taken place using these verifications and confirmations.

A Cookie B′ and a secret value B″ are set as screen data in the screen B. The Cookie B′ is correlated with the screen B and stored in the screen table 130.

In the case (s20) of receiving a display request of screen C from the to client 200, the server 100 verifies a Cookie within the received data with the Cookie B′, confirms whether a transfer source screen is the screen B, and confirms whether screen C can be transferred. In addition, the server 100 confirms whether the received secret value B″ matches a recalculated secret value using the received Cookie, and screen C is displayed when a valid access attempt is judged to have taken place using these verifications and confirmations judges. The subsequent operations are similarly performed in screen C.

In the case (s30) of receiving a display request of screen D from the client 200, the server 100 verifies a Cookie within the received data with the Cookie A, confirms whether a transfer source screen is the screen A, and confirms whether screen D can be transferred. In addition, the server 100 confirms whether the received secret value A matches a recalculated secret value using the received Cookie, and screen D is displayed when a valid access attempt is judged to have taken place using these verifications and confirmations.

The Cookie 0′ and secret value D″ are set as screen data in the screen D. The Cookie D′ is correlated with the screen D and stored in the screen table 130. The same operations are performed as in the case of transfer from the screen D to a different screen.

In FIG. 2, for example, the Cookie B′ and secret value: B″ are required when displaying the screen C even when attempting to transfer from the screen A to the screen C. If the transfer does not pass via the screen B, access is denied because the Cookie B′ and secret value B″ can not be obtained in the client 200, in this way, it is possible to remove an invalid access attempt without going through a valid screen transfer.

Next, a data processing method related to one embodiment of the present invention, that is, the flow of data processes which use a data processing device related to one embodiment of the present invention, is explained.

First, in the data processing device related to one embodiment of the present invention, the processes for sending screen data to a client, that is, the flow of a series of operations in the generation part 110 is explained. Furthermore, a detailed explanation of operations in each structure already explained is omitted.

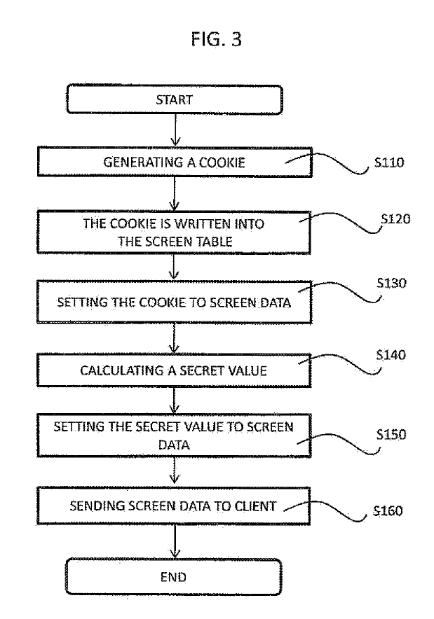

FIG. 3 is a flowchart for explaining the flow of processes when sending screen data to a client in the data processing device related to one embodiment of the present invention.

First, referring to FIG. 3, a Cookie is generated in the Cookie generator 111 (S110). The generation method of a Cookie is as explained above.

Next, the generated Cookie is written into the screen table 130 (S120). The Cookie is correlated with the screen of the transfer source or the screen of the transfer destination and stored.

The generated Cookie is set to screen data (S130). Furthermore, setting the Cookie to screen data may be carried out after a step S140 or after a step S150 described below.

A calculation is made using a predetermined function in the calculator 112 using the generated Cookie and a hidden key 140, and a secret value is calculated (S140). After the calculation it is preferable that the secret value 140 is stored in a temporary memory region, of the server 100.

The calculated secret value is set to screen data (S150). The secret value is set to the screen data in a format which is not displayed on the screen of the client 200. It is preferable that the secret value is deleted from the temporary memory region of the server 100 after setting to the screen data.

The screen data is sent to the client 200 by the screen sender 113 (S160) and the operations of the generation part 110 are completed.

Furthermore, as described above, the screen table 130 is not essential and a generated Cookie may be written into a table without correlating with a screen.

Next, in the data processing device related to one embodiment of the present invention, the process whereby a screen display request is received from a client and the validity of this display request is judged, that is, the flow of a series of operations in the verification unit 120 is explained. Furthermore, a detailed explanation of operations in each structure already explained is omitted.

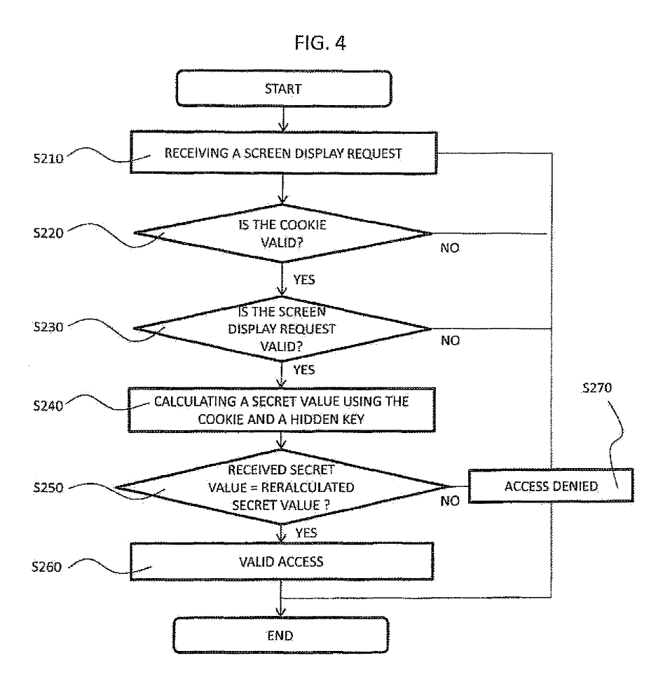

FIG. 4 is a flowchart for explaining the flow of processes whereby a screen display request is received from a client and the validity of the screen request is judged in the data processing device related to one embodiment of the present invention.

Referring to FIG. 4, first, a screen display request is received by the server 100 from the client 200 (S210). A Cookie and a secret value are included in the screen display request. In the case where a Cookie and secret value are not included, it is judged that an invalid access is being attempted in the subsequent steps and access is denied.

Next, the Cookie verification unit 122 verifies whether the received Cookie matches the Cookie stored in the screen table 130 and judges the validity of the Cookie (S220). In the case where the received Cookie does not match the Cookie stored in the screen table 130 or a Cookie is not received, a judgment is made that en invalid access attempt has been made and access is denied (S270). In case where the received Cookie matches the Cookie stored in the screen table 130, the process proceeds to step S230.

The screen verification unit 123 judges whether transfer from the present screen, that is, from the transfer source screen, to the transfer destination screen is possible or not (S230). A transfer source screen or transfer destination screen is confirmed by referencing a corresponding Cookie in the screen table 130, or a transfer source screen is confirmed using a referrer for example, and a judgment is made whether transfer from the transfer source screen to the transfer destination screen is possible or not. In the case where it is judged that transfer to the transfer destination screen is not possible, access is denied as an invalid access attempt (S270). In the case where it is judged that transfer is possible, the process proceeds to step S240.

Furthermore, as described above, step S230 can be omitted in the case where the screen table 130 is not arranged and therefore a Cookie is not correlated with a screen and a generated Cookie is simply written to a table, and the process can proceed to step S240.

A secret value is again calculated in the secret value verification unit 124 using a similar calculation method as the calculation performed in the calculator 112 using the received Cookie and a hidden key 140 (S240).

The secret value verification unit 124 verifies whether the received secret value and the recalculated secret value match or not (S250). In the case where the received secret value and the recalculated secret value do not match, or if a secret value is not include in the screen display request and a secret value is not received, it is judged that an invalid access attempt has been made and access is denied (S270). In the case where the received secret value and the recalculated secret value match, it is judged that the access attempt is valid and the transfer destination screen is displayed (S260). When displaying the transfer destination screen, the operations in the generation part 110 explained using FIG. 3 may be repeated in a new screen.

As stated above, according to the data processing method related to one embodiment of the present invention, it is possible to utilize a Cookie in session management that is management of each transfer screen. In addition, even if a Cookie is leaked to a third party, because the secret value, can not be calculated or guessed with the Cookie alone by the third party and processes related to the secret value within the server 100 can not be known, it is possible to prevent invalid access using a leaked Cookie.

In addition, according to the data processing method related to one embodiment of the present invention, by having a screen table 130 which stores a screen correlated with a Cookie and by confirming a transferable screen by checking the screen table 130 it is possible to remove invalid access attempts from valid screen transfers.

What is claimed is:

1. A data processing device connected to a client via a network comprising:
a Cookie generator which generates a Cookie;
a calculator which calculates a secret value using the Cookie and a hidden key which is a predetermined character string;
a screen sender which sends screen data, which include the Cookie and the secret value, to the client;
a table which stores the Cookie;
a request telegraph receiver which receives a request telegraph, which includes a request Cookie and a request secret value, from the client;
a Cookie verification unit which verifies whether the Cookie stored in the table and a received Cookie, which is the request Cookie in the request telegraph, match; and
a secret value verification unit which verifies whether a value calculated based on the received Cookie and the hidden key matches the request secret value in the request telegraph.

2. A data processing device connected to a client via a network comprising:
a Cookie generator which generates a different Cookie for each screen displayed;
a calculator which calculates a secret value using the Cookie and a hidden key which is a predetermined character string;
a screen sender which sends screen data, which include the Cookie and the secret value, to the client;
a screen table which correlates a transferable screen, which is transferable from a screen corresponding to the screen data, with the Cookie and stores both the transferable screen and the Cookie;
a request telegraph receiver which receives a request telegraph, which includes a request Cookie, a request secret value and request screen transfer destination data, from the client;
a Cookie verification unit which verifies whether the Cookie stored in the screen table and a received Cookie, which is the request Cookie in the request telegraph, match;
a screen verification unit which verifies whether a screen transfer destination, which is desired by the client and included in the request screen transfer destination data, is included in the transferable screen corresponding to the Cookie stored in the screen table; and
a secret value verification unit which verifies whether a value calculated based on the received Cookie and the hidden key matches the request secret value in the request telegraph.

3. The data processing device according to claim 2, wherein the screen sender deletes the secret value from the data processing device after the screen data is sent.

4. The data processing device according to claim 1, wherein the screen data is written in HTML and the hidden key is set to the screen data as a hidden parameter in a <form> tag.

5. The data processing device according to claim 2, wherein the screen data is written in HTML and the hidden key is set to the screen data as a hidden parameter in a <form> tag.

6. The data processing device according to claim 3, wherein the screen data is written in HTML and the hidden key is set to the screen data as a hidden parameter in a <form> tag.

7. A data processing method at a data processing device connected to a client via a network comprising:
generating a different Cookie for each screen displayed;
calculating a secret value using the generated Cookie and a hidden key which is a predetermined character string;
sending screen data which include the generated Cookie and the calculated secret value to the client;
correlating a transferable screen which is more transferable than a screen corresponding to the screen data, with the Cookie and storing both the transferable screen and the Cookie;
receiving a request telegraph which includes the Cookie, the secret value and request screen transfer destination data from the client;
verifying whether the Cookie stored in a table matches a received Cookie from the request telegraph;
verifying whether a screen transfer destination, which is desired by the client included in the request screen transfer destination data, is included in the transferable screen corresponding to the Cookie stored in the screen table; and verifying whether a value calculated using the received Cookie and the hidden
key matches a secret value included in the request telegraph.
